(19) United States
(12) Patent Application Publication
(10) Pub. No.: US 2026/0227216 A1
(43) Pub. Date: Aug. 6, 2026

(54) MEASUREMENT APPARATUS

(71) Applicant: FUJI ELECTRIC CO., LTD., Kanagawa (JP)

(72) Inventors: Fumiya UENO, Matsumoto-city (JP); Hiroto KIKUCHI, Matsumoto-city (JP); Ko SATO, Matsumoto-city (JP)

(21) Appl. No.: 19/653,125

(22) Filed: Apr. 21, 2026

Related U.S. Application Data
(63) Continuation of application No. PCT/JP2025/013557, filed on Apr. 2, 2025.

(30) Foreign Application Priority Data
May 13, 2024 (JP) 2024-078192

(51) Int. Cl. G01F 1/36; G01F 1/50

(52) U.S. Cl. CPC G01F 1/363; G01F 1/50

(57) ABSTRACT

There is provided a measurement apparatus for measuring a pressure difference of a fluid between a first position and a second position in a flow passage of the fluid, the measurement apparatus comprising a first pressure sensor which is provided at the first position and which outputs a first electric potential corresponding to a pressure of the fluid, a second pressure sensor which is provided at the second position and which outputs a second electric potential corresponding to a pressure of the fluid, and an electric potential difference detection unit which detects an electric potential difference between the first electric potential and the second electric potential, and converts the electric potential difference into the pressure difference.

The contents of the following patent application(s) are incorporated herein by reference:
NO. 2024-078192 filed in JP on May 13, 2024
NO. PCT/JP2025/013557 filed in WO on Apr. 2, 2025.

### BACKGROUND

### 1. Technical Field

The present invention relates to a measurement apparatus.

### 2. Related Art

Conventionally, a fuel cell cooling system in which a temperature sensor or a pressure sensor is disposed near a water pump is known (for example, see Patent Document 1.) Furthermore, a configuration is known where pressure sensors are respectively provided on a coolant discharge side and a coolant inlet side of an electric water pump equipped with a sensorless brushless motor (see, for example, Patent Document 2). In addition, Patent Document 3 describes a diffuser for a low-pressure steam turbine stage.

### RELATED ART DOCUMENTS

### Patent Documents

Patent Document 1: Japanese Patent Application Publication No. 2018-181654
Patent Document 2: Japanese Patent Application Publication No. 2009-264288
Patent Document 3: Japanese Patent Application Publication No. 2014-1735

### BRIEF DESCRIPTION OF THE DRAWINGS

FIG. 1 is a diagram illustrating an example of a cooling system 100 in which a measurement apparatus 20 according to an embodiment of the present invention is used.

FIG. 2 is a diagram illustrating a method for calculating a flow rate from pressure.

FIG. 3 is a diagram illustrating a circuit configuration of the measurement apparatus 20 according to an embodiment.

FIG. 4 is a diagram illustrating a timing at which an electric potential difference detection unit 24 detects an output from a pressure sensor.

FIG. 5 is a diagram illustrating a circuit configuration of a measurement apparatus 200 according to a comparative example.

FIG. 6 is a diagram illustrating a circuit configuration of the measurement apparatus 200 according to another comparative example.

FIG. 7 is a diagram illustrating a timing at which the electric potential difference detection unit 24 according to a comparative example detects an output from a pressure sensor.

FIG. 8 is a diagram illustrating a result of calculating the flow rate by the measurement apparatus 20 according to an embodiment.

FIG. 9 is a diagram illustrating a result of calculating the flow rate by the measurement apparatus 200 according to a comparative example.

FIG. 10 is a diagram illustrating a circuit configuration according to a modified example of the measurement apparatus 20.

FIG. 11 is a diagram illustrating an example of a process of converting an electric potential difference into a pressure difference in the measurement apparatus 20.

FIG. 12 is a diagram illustrating a configuration and an attachment example of a pressure sensor according to an embodiment of the present invention.

FIG. 13 is a diagram illustrating a configuration example of a part of the measurement apparatus 20 according to an embodiment of the present invention.

FIG. 14A is a diagram illustrating an arrangement of a pressure sensor at a connection point 80 of a flow passage 50.

FIG. 14B is a diagram illustrating another example of the connection point 80.

FIG. 14C is a diagram illustrating another example of the connection point 80.

FIG. 15 is a diagram illustrating a circuit configuration of the measurement apparatus 20 according to a second embodiment of the present invention.

FIG. 16 is a diagram illustrating another example of the connection point 80.

FIG. 17A is a diagram illustrating an output after a first low-pass filter 30-1 in FIG. 16.

FIG. 17B is a diagram illustrating an output after a second low-pass filter 30-2 in FIG. 16.

FIG. 17C is a diagram illustrating an output difference (electric potential difference) between FIG. 17A and FIG. 17B.

FIG. 18A is a diagram illustrating an output from a first pressure sensor 21 according to a comparative example.

FIG. 18B is a diagram illustrating an output from the second pressure sensor 22 according to a comparative example.

FIG. 18C is a diagram illustrating an output difference (electric potential difference) between FIG. 18A and FIG. 18B.

### DESCRIPTION OF EXEMPLARY EMBODIMENTS

The present invention will be described below through embodiments of the invention, but the following embodiments do not limit the invention according to the claims. In addition, not all of the combinations of features described in the embodiments are essential to the solving means of the invention. Note that in the present specification and the diagrams, elements having substantially the same function and architecture are denoted with a same reference sign to omit duplicated descriptions, and illustrations of elements that are not directly related to the present invention will be omitted. Further, in one diagram, elements having the same functions and architecture are denoted by a representative reference sign, and other reference signs for the elements may be omitted.

In the present specification, technical matters may be described using orthogonal coordinate axes of an X axis, a Y axis, and a Z-axis. The orthogonal coordinate axes merely specify relative positions of components, and do not limit a specific direction. For example, the Z-axis is not limited to indicate the height direction with respect to the ground. Note that a +Z-axis direction and a-Z-axis direction are directions opposite to each other. When the Z-axis direction is described without describing the signs, it means that the direction is parallel to the +Z-axis and the −Z-axis.

When a term such as “same” or “equal” is used herein, it may encompass a case where an error due to a variation in manufacturing or the like is included. The error is, for example, within 10%.

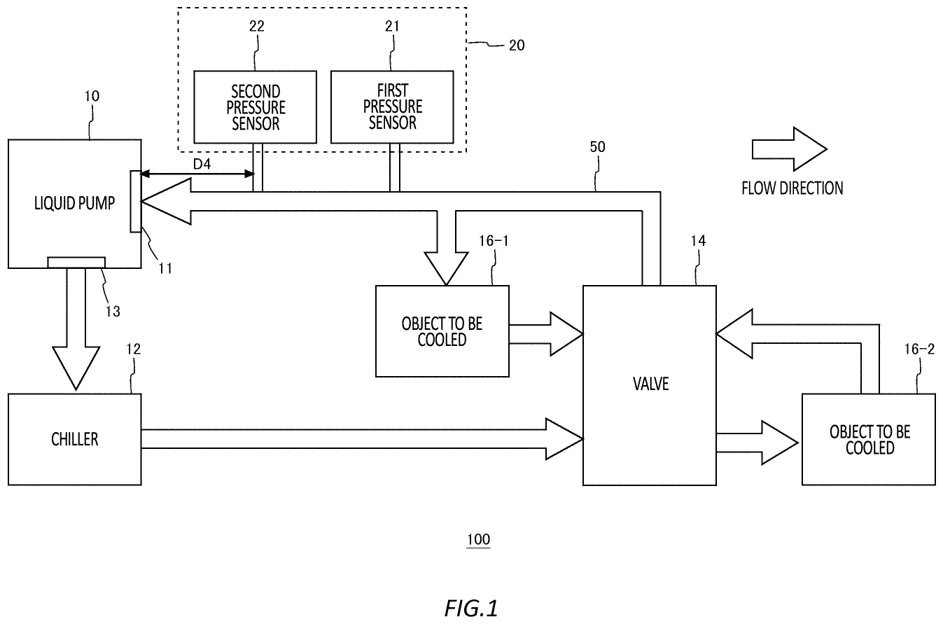

FIG. 1 is a diagram illustrating an example of a cooling system 100 in which a measurement apparatus 20 according to an embodiment of the present invention is used. The cooling system 100 is, for example, a thermal management system for xEVs, such as an EV (electric vehicle), an HEV (hybrid vehicle), a PHEV (plug-in hybrid vehicle), and an FCV (fuel cell vehicle). The cooling system 100 cools an object to be cooled by circulating a fluid (coolant).

The cooling system 100 includes a liquid pump 10, a chiller 12, a valve 14, an object to be cooled 16, a measurement apparatus 20, and a flow passage 50. In FIG. 1, directions in which the fluid flows along the flow passage 50 is indicated by arrows. Each component is connected by piping or the like forming the flow passage 50.

The liquid pump 10 is a water pump which causes the fluid to flow through the flow passage 50 and circulate. The liquid pump 10 has a suction port 11 for suctioning the fluid and a discharge port 13 for discharging the fluid. The chiller 12 performs temperature control of the fluid.

The valve 14 controls the flow rate of the fluid flowing through the flow passage 50 connected to the object to be cooled 16. The valve 14 of the present example is a multi-way valve which controls the flow rate of the fluid flowing to an object to be cooled 16-1 and an object to be cooled 16-2. The valve 14 may be an electrically controlled valve, or may be a solenoid valve.

The object to be cooled 16 is, as an example, various components such as a motor, a battery, or an inverter in an electric vehicle, or a system for cooling an interior space. The cooling system 100 of the present example cools the object to be cooled 16-1 and the object to be cooled 16-2.

Since cooling performance of the cooling system 100 depends on the flow rate of the fluid flowing through the flow passage 50, the temperature of the object to be cooled 16 is controlled within an appropriate range by controlling the flow rate. In controlling the flow rate, a method of indirectly grasping and controlling the flow rate using control values such as the rotation speed, power, or the like of the liquid pump 10 is common. For example, increasing the rotation speed of the liquid pump 10 causes the flow rate to increase, and decreasing the rotation speed causes the flow rate to decrease.

However, the above-described method has a problem in that, when a correlation between the rotation speed of the liquid pump 10 and the flow rate is lost, the flow rate can no longer be controlled. For example, if clogging occurs in a part of the flow passage 50 for the fluid, the flow rate may decrease or the flow may stop. In this case, in a system that grasps and controls the flow rate based on the rotation speed of the liquid pump 10, the actual flow rate does not increase even if the rotation speed of the liquid pump 10 is increased, making it impossible to grasp the actual flow rate. As a result, a failure of the object to be cooled 16 due to excessive heat and a failure of the liquid pump 10 due to excessive load may occur. In addition, in a low-flow-rate region in which rotation of a rotor of the liquid pump 10 is slow, an induced voltage decreases, making it difficult to detect the rotation speed itself of the liquid pump 10 (see, for example, Patent Document 3). Therefore, it is desirable to measure the flow rate by another method.

The cooling system 100 of the present example has the measurement apparatus 20 attached thereto. The measurement apparatus 20 measures the flow rate of the fluid of the cooling system 100. The measurement apparatus 20 of the present example calculates the flow rate of the fluid by measuring a pressure of the fluid. The measurement apparatus 20 includes a first pressure sensor 21 and a second pressure sensor 22.

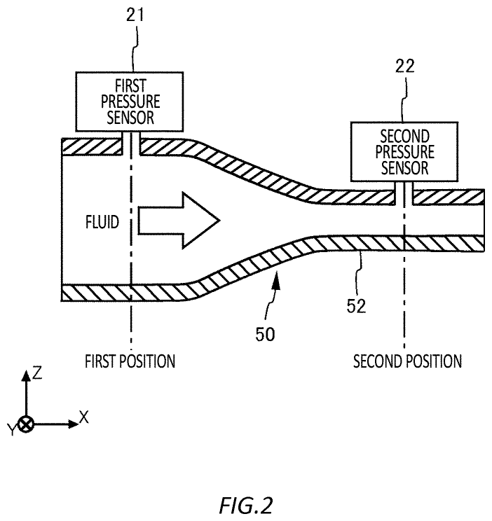

FIG. 2 is a diagram illustrating a method for calculating the flow rate from pressure. FIG. 2 is an enlarged view of a pressure sensor and a vicinity of the flow passage 50 in FIG. 1. In FIG. 2, the fluid flows in a positive direction of the X-axis within the flow passage 50. FIG. 2 is the cross-sectional view of the flow passage 50 in a direction parallel to the flow direction. The flow passage 50 is a pipe formed by a tubular housing 52 such as a cylinder.

As a method for calculating a flow rate from pressure, there is a method in which pressures before and after a different-diameter pipe, such as an orifice or a Venturi tube, are compared, and the flow rate is calculated from the pressure difference. The flow passage 50 in FIG. 2 is also a different-diameter pipe. By measuring respective pressure differences between a pressure P₁ at a first position and a pressure P₂ at a second position of the different-diameter pipe, and by solving simultaneous equations of the following Equation (1) and Equation (2) from Bernoulli's principle, a flow rate Q can be calculated.

$$\begin{matrix}Equation 1 & \\ \frac{1}{2} {pv}_{1}^{2} + {P}_{1} + {pgh}_{1} = \frac{1}{2} {pv}_{2}^{2} + {P}_{2} + {pgh}_{2} & ( 1 )\end{matrix}$$

$$\begin{matrix}Equation 2 & \\ Q = {v}_{1} \cdot {S}_{1} = {v}_{2} \cdot {S}_{2} & ( 2 )\end{matrix}$$

Here, ρ represents the density of the fluid, v represents the flow velocity of the fluid, S represents the cross-sectional area of the flow passage 50, g represents the gravitational acceleration, h represents the height of the flow passage 50, and a subscript 1 or 2 represents a value at the first position or the second position.

As one method for measuring a pressure difference between two positions, there is a method (a differential pressure measurement method) in which the two positions are connected by another route such as a bypass and a differential pressure sensor is inserted therein. In that case, since another route is provided to measure the pressure difference, the flow passage 50 becomes complicated.

As another method for measuring the pressure difference between two positions, there is a method (a two-point measurement method) in which pressure sensors are installed at the two positions, respectively, and the pressure difference is calculated. In the case of the two-point measurement method, there is no need to make the flow passage 50 complicated, and it is easy to attach in existing equipment. In the present embodiment, a flow rate of the fluid is calculated by using the two-point measurement method in the cooling system 100.

The measurement apparatus 20 measures the pressure difference of the fluid at the first position and the second position in the flow passage 50. The first pressure sensor 21 is provided at the first position and outputs a first electric potential corresponding to the pressure of the fluid. The second pressure sensor 22 is provided at the second position and outputs a second electric potential corresponding to the pressure of the fluid. As an example, the first pressure sensor 21 and the second pressure sensor 22 are the semiconductor piezoresistive pressure sensors.

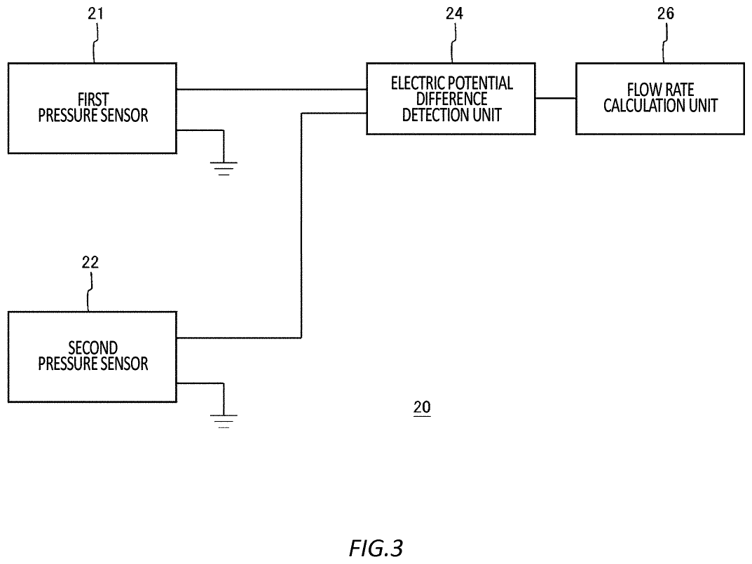

FIG. 3 is a diagram illustrating a circuit configuration of the measurement apparatus 20 according to an embodiment. The measurement apparatus 20 includes, in addition to the first pressure sensor 21 and the second pressure sensor 22, an electric potential difference detection unit 24 and a flow rate calculation unit 26. The first pressure sensor 21 outputs the first electric potential to the electric potential difference detection unit 24, and the second pressure sensor 22 outputs the second electric potential to the electric potential difference detection unit 24.

The electric potential difference detection unit 24 detects an electric potential difference between the first electric potential and the second electric potential, and converts the electric potential difference into a pressure difference. An output terminal of the first pressure sensor 21 and an output terminal of the second pressure sensor 22 may be directly connected to an input terminal of the electric potential difference detection unit 24. To be directly connected may mean being connected without another circuit element included therebetween, and may mean not including an AD converter therebetween. The electric potential difference detection unit 24 outputs the converted pressure difference to the flow rate calculation unit 26. The electric potential difference detection unit 24 is, as an example, the AD converter.

The flow rate calculation unit 26 is an electronic computer which obtains the pressure difference output from the electric potential difference detection unit 24 and calculates the flow rate of the fluid from the pressure difference. The flow rate calculation unit 26 may calculate the flow rate by using the above-described Equation (1) and Equation (2). The flow rate calculation unit 26 may display a calculation result on a monitor or the like, and may transmit the calculation result to another apparatus.

The first electric potential and the second electric potential may be analog signals. The electric potential difference detection unit 24 may detect the electric potential difference, which is a difference between a first electric potential analog signal indicating the first electric potential and a second electric potential analog signal indicating the second electric potential, and may convert the electric potential difference into the pressure difference as a digital signal.

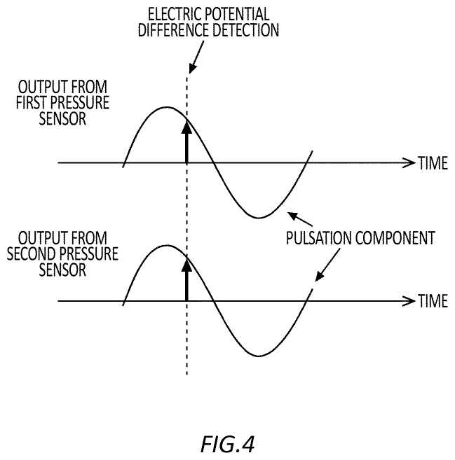

FIG. 4 is a diagram illustrating a timing at which an electric potential difference detection unit 24 detects an output from a pressure sensor. In FIG. 4, the output (the first electric potential) of the first pressure sensor 21 and the output (the second electric potential) of the second pressure sensor 22 are respectively illustrated. The horizontal axis of FIG. 4 represents time.

The fluid flowing through the flow passage 50 has a pulsation component. Pulsation is a phenomenon in which the flow rate or the flow velocity of the fluid periodically changes. For example, the pulsation occurs due to rotation of a pump. Therefore, the pulsation component also appears in the output from the first pressure sensor 21 and the output from the second pressure sensor 22. FIG. 4 represents only the pulsation component out of the output from the first pressure sensor 21 and the output from the second pressure sensor 22.

According to the measurement apparatus 20 of the embodiment illustrated in FIG. 3, since the electric potential difference between the first electric potential and the second electric potential is detected, the timings at which the first electric potential and the second electric potential are detected become simultaneous, or a timing difference therebetween becomes so small as to be negligible. That is, the pulsation component included in the first electric potential and the pulsation component included in the second electric potential become equal. In FIG. 4, the timings for detecting the electric potential difference is indicated by dashed lines, and the respective pulsation component at the timing is indicated by thick arrows. Then, since the difference between the first electric potential and the second electric potential is taken, the respective pulsation components cancel each other out. Therefore, even if the fluid pulsates, the value of the pressure difference is stabilized, and measurement accuracy is improved.

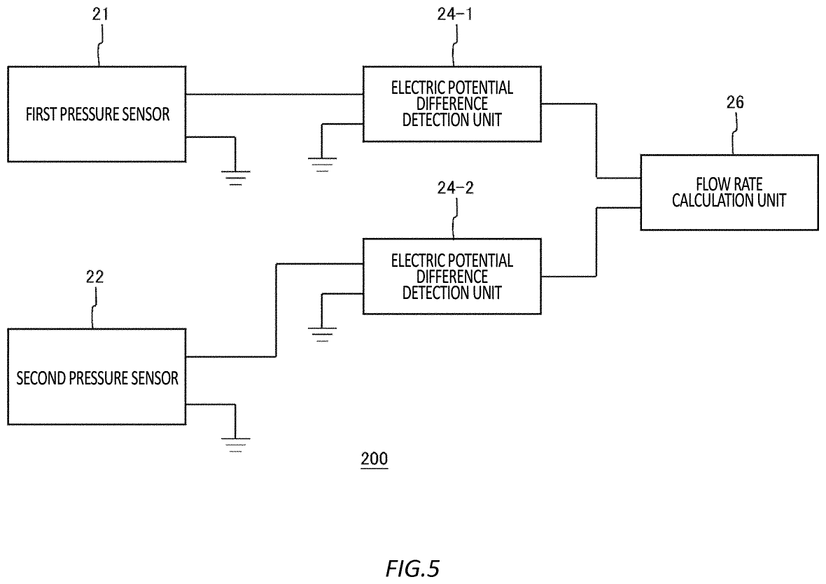

FIG. 5 is a diagram illustrating a circuit configuration of a measurement apparatus 200 according to a comparative example. The measurement apparatus 200 of the present example differs from the measurement apparatus 20 illustrated in FIG. 3 in that the electric potential difference detection unit 24 is provided for each pressure sensor. The measurement apparatus 200 includes an electric potential difference detection unit 24-1 and an electric potential difference detection unit 24-2.

The electric potential difference detection unit 24-1 detects the output (the first electric potential) of the first pressure sensor 21, compares the first electric potential with a reference electric potential, and converts the first electric potential into a pressure value at the first position (the first pressure value). Similarly, the electric potential difference detection unit 24-2 detects the output (the second electric potential) of the second pressure sensor 22, compares the second electric potential with the reference electric potential, and converts the second electric potential into a pressure value at the second position (the second pressure value). The reference electric potential may be a ground electric potential. The flow rate calculation unit 26 obtains the above-described pressure difference by calculating the difference between the first pressure value and the second pressure value. The calculation of the flow rate from the pressure difference is performed in the same manner as in the case of FIG. 3.

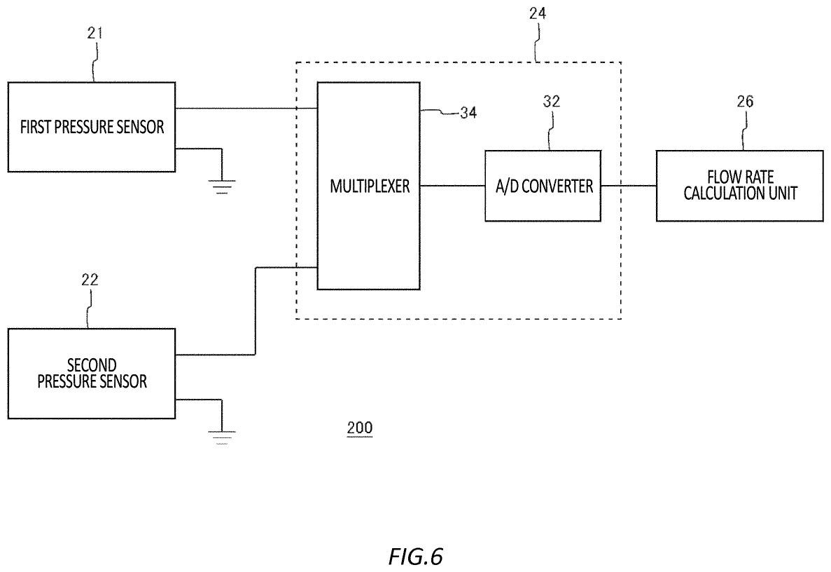

FIG. 6 is a diagram illustrating a circuit configuration of the measurement apparatus 200 according to another comparative example. The measurement apparatus 200 of the present example includes one the electric potential difference detection unit 24. The electric potential difference detection unit 24 of the present example is a multi-channel A/D conversion circuit having an A/D converter 32 and a multiplexer 34.

In a multi-channel A/D conversion circuit, since an A/D converter 32 needs to be provided for each channel to perform simultaneous conversion, the circuit size increases, resulting in higher cost. Therefore, a multi-channel A/D conversion circuit generally includes one A/D converter 32 and converts a plurality of channels by switching inputs using the multiplexer 34. The electric potential difference detection unit 24 in FIG. 6 shows a general multi-channel A/D conversion circuit. Specifically, the multiplexer 34 selects Channel 1, and the A/D converter 32 converts the first electric potential. Subsequently, Channel 2 is selected, and the second electric potential is converted. That is, the timing at which the first electric potential is converted and the timing at which the second electric potential is converted are not simultaneous.

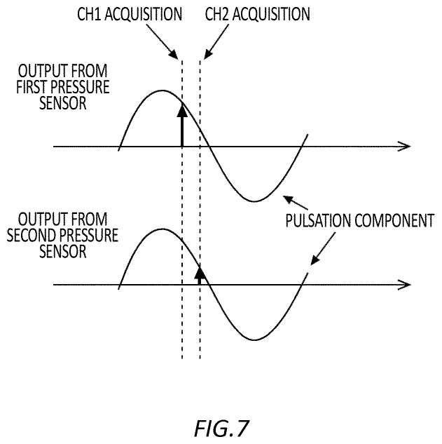

FIG. 7 is a diagram illustrating the timing at which the electric potential difference detection unit 24 according to a comparative example detects the output from the pressure sensor. In any of the comparative examples illustrated in FIG. 5 and FIG. 6, a time lag occurs in the timing at which the output from the pressure sensor is detected. FIG. 7 illustrates the example illustrated in FIG. 6. Dashed lines indicate the timing for converting the output from the first pressure sensor 21 in Channel 1 and the timing for converting the output from the second pressure sensor 22 in Channel 2. Since the two timings are different, the pulsation component included in the output from the first pressure sensor 21 and the pulsation component included in the output from the second pressure sensor 22 are not equal. As a result, an error due to the pulsation components occurs, and measurement accuracy deteriorates.

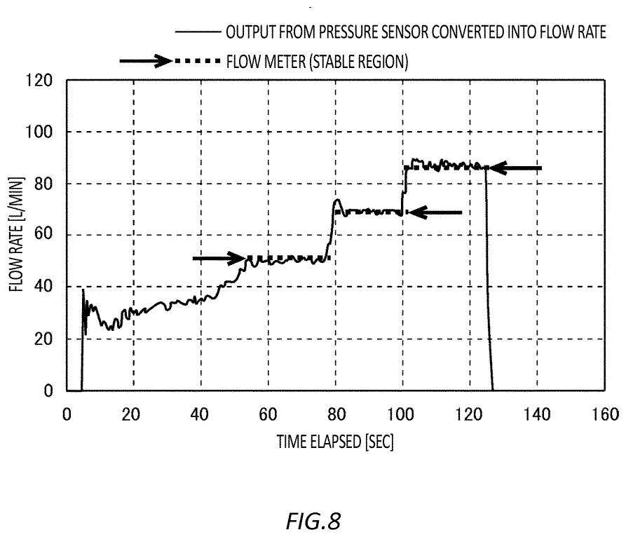

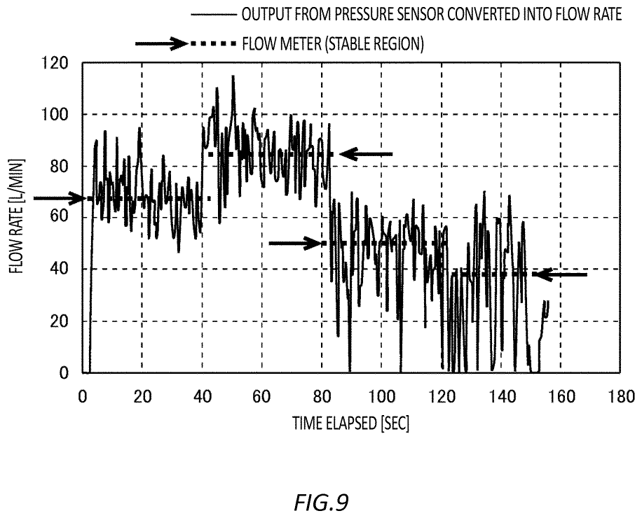

FIG. 8 is a diagram illustrating the result of calculating the flow rate by the measurement apparatus 20 according to an embodiment. FIG. 9 is a diagram illustrating the result of calculating the flow rate by the measurement apparatus 200 according to a comparative example. In the graphs of FIG. 8 and FIG. 9, the horizontal axis represents time, and the vertical axis represents the calculated flow rate. The solid line in the figures represents results of the flow rate calculated by the measurement apparatus 20. Further, for comparison, the flow rate was measured using a flowmeter. The constant value indicated by the dashed line and the arrow in the figure indicates a portion where values of the flow rate measured using the flowmeter are stable.

The values of the flow rate values calculated by the measurement apparatus 20 according to the embodiment are stable near the flow rate values of the flowmeter, and no significant error is observed. On the other hand, in the measurement apparatus 200 according to the comparative example, errors due to the pulsation component are large, and the values of the calculated flow rate are not stable. That is, in the measurement apparatus 20 of the embodiment, it was confirmed that it was possible to improve measurement accuracy by removing pulsation components.

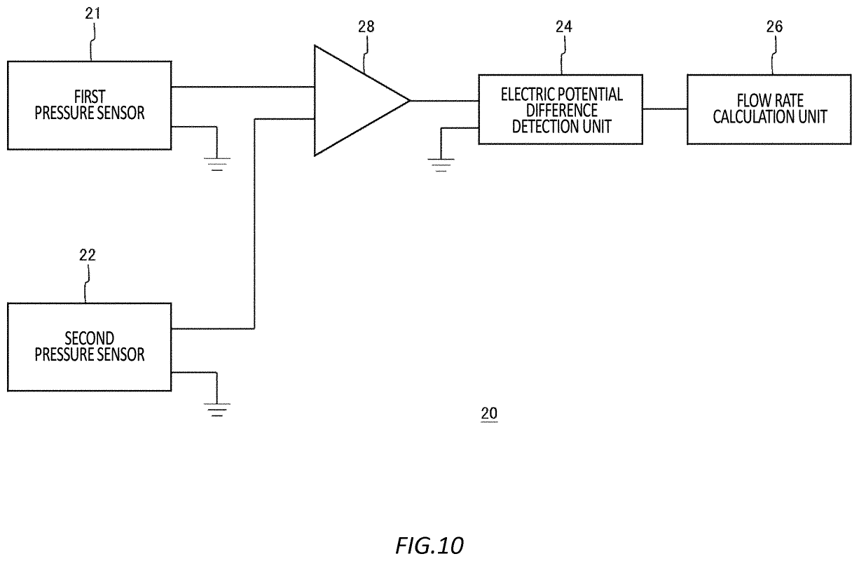

FIG. 10 is a diagram illustrating the circuit configuration according to the modified example of the measurement apparatus 20. The measurement apparatus 20 of the present example further includes a differential amplifier 28 in addition to the example illustrated in FIG. 3. The differential amplifier 28 amplifies the electric potential difference between the first electric potential, that is the output from the first pressure sensor 21, and the second electric potential, that is the output from the second pressure sensor 22, and outputs the amplified electric potential difference to the electric potential difference detection unit 24.

Also in the present example, the first electric potential and the second electric potential may be analog signals. That is, the differential amplifier 28 amplifies a difference between the first electric potential analog signal indicating the first electric potential and the second electric potential analog signal indicating the second electric potential, and outputs an electric potential difference analog signal indicating the electric potential difference. The output terminal of the first pressure sensor 21 and the output terminal of the second pressure sensor 22 may be directly connected to the two input terminals of the differential amplifier 28. The output terminal of the differential amplifier 28 may be directly connected to the input terminal of the electric potential difference detection unit 24. Also with such a configuration, the timings for detecting the outputs of the pressure sensors are aligned, and thus the pulsation components can be canceled out, improving the measurement accuracy.

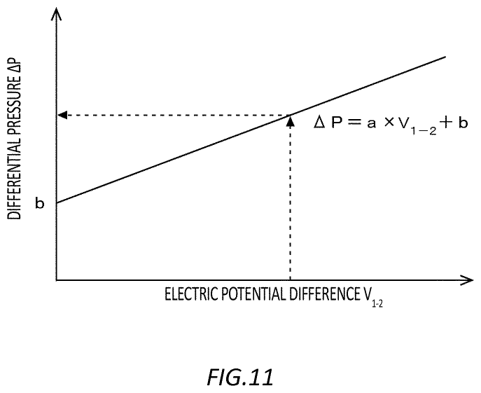

FIG. 11 is a diagram illustrating the example of the process of converting the electric potential difference into the pressure difference in the measurement apparatus 20. In FIG. 11, the horizontal axis represents the electric potential difference, and the vertical axis represents the pressure difference. The electric potential difference detection unit 24 may obtain in advance a relational expression representing a relationship between the pressure difference and the electric potential difference. The relational expression of the present example is a linear function in which a gradient of “a” and an intercept of “b.”

In a case where the electric potential difference detection unit 24 of the present example detects a certain electric potential difference, the electric potential difference detection unit 24 determines a value obtained by multiplying the electric potential difference by a gradient “a” and adding an intercept “b” as the pressure difference.

The gradient a is a parameter determined by sensitivity of the pressure sensors, and is calibrated at the time of shipment. On the other hand, the intercept b is an offset value representing the electric potential difference in a state in which no fluid is flowing through the flow passage 50. The electric potential difference detection unit 24 may obtain in advance the gradient a and the intercept b. The electric potential difference detection unit 24 may correct the pressure difference using the intercept b. This further improves the measurement accuracy.

Here, the intercept b changes due to, for example, stress relaxation of an adhesive when attaching the pressure sensor or the like. Therefore, the electric potential difference detection unit 24 may periodically obtain the intercept b and update the value of the intercept b. This further improves the measurement accuracy.

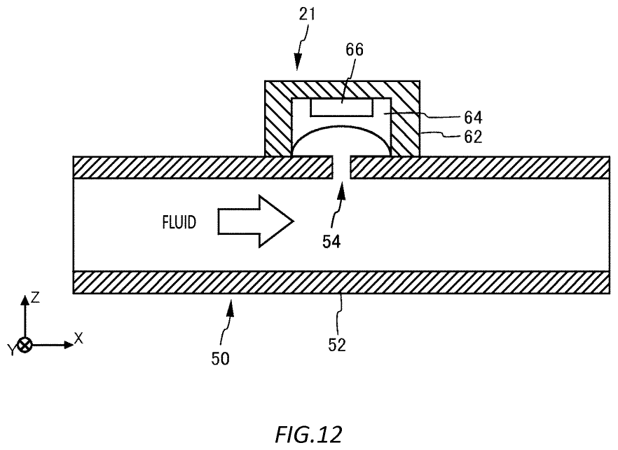

FIG. 12 is a diagram illustrating the configuration and the attachment example of the pressure sensor according to an embodiment of the present invention. The pressure sensor of the present example is attached to the flow passage 50. In FIG. 12, the first pressure sensor 21 is described as an example, but the second pressure sensor 22 and other pressure sensors may be similar. The first pressure sensor 21 includes a housing 62, a coating agent 64, and a sensor unit 66.

The housing 62 is a casing of the first pressure sensor 21. The coating agent 64 and the sensor unit 66 are provided inside the housing 62. The housing 62 and the housing 52 of the flow passage 50 may be attached by the adhesive. The housing 52 of the flow passage 50 is provided with a hole 54 for causing the fluid to flow into the inside of the housing 62. The sensor unit 66 is protected from the fluid flowing into the inside of the housing 62 by the coating agent 64 such as gel.

The sensor unit 66 detects the pressure of the fluid. As an example, the sensor unit 66 is provided with a semiconductor piezoresistive pressure sensor formed in a semiconductor chip. However, as an example, the sensor unit 66 may be provided with a diode or a resistance element formed in a semiconductor chip for temperature detection. Thus, the sensor unit 66 can detect the pressure and temperature of the fluid.

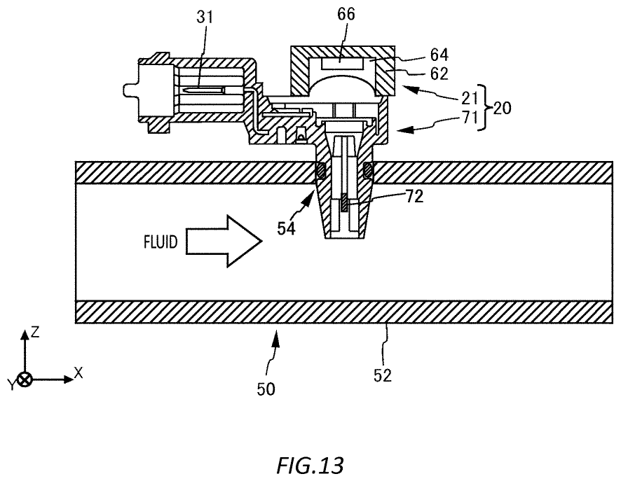

FIG. 13 is a diagram illustrating the configuration example of the part of the measurement apparatus 20 according to an embodiment of the present invention. Also in the present example, the first pressure sensor 21 will be described as an example of the pressure sensor. The measurement apparatus 20 of the present example includes a temperature sensor 71 in addition to the first pressure sensor 21. The first pressure sensor 21 is attached to the opposite side of the temperature sensor 71 from the channel 50.

The temperature sensor 71 detects the temperature of the fluid. A thermistor 72 is provided in a vicinity of a tip of the temperature sensor 71. The temperature sensor 71 is fixed through the housing 52 of the flow passage 50, and the vicinity of the tip where the thermistor 72 is provided is located inside the flow passage 50. A resistance temperature detector (RTD) or a thermocouple may be used instead of the thermistor 72.

Although a detailed description of the inside of the temperature sensor 71 is omitted, the vicinity of the temperature sensor 71 where the thermistor 72 is provided has a hollow interior, and has a structure that allows the fluid to flow into the inside of the temperature sensor 71 in a positive direction of the Z-axis. Therefore, the fluid reaches the first pressure sensor 21, and the pressure of the fluid is measured by the sensor unit 66. Also with such a configuration, the pressure of the fluid can be measured, and the temperature of the fluid can also be measured.

The first pressure sensor 21 may have an output terminal 31. The first pressure sensor 21 may output the first electric potential from the output terminal 31 to the electric potential difference detection unit 24. The temperature sensor 71 may also have the output terminal 31. The temperature sensor 71 may output the electric potential of the thermistor 72 or the like from the output terminal 31 to the outside.

The electric potential difference detection unit 24 may obtain the above-described offset value (intercept b in FIG. 11) for each temperature of the fluid. For example, the temperature of the fluid changes depending on an operating state of the object to be cooled 16 or the liquid pump 10. Thereby, the offset value also changes. Therefore, the pressure difference can be corrected more accurately by obtaining the offset value for each temperature in advance. The electric potential difference detection unit 24 may select the offset value to be used in accordance with a measurement result of the temperature sensor 71.

Also, a liquid density p generally has temperature dependence. Therefore, by using or obtaining in advance data of the liquid density p for each temperature of the liquid to be used, the flow rate calculation unit 26 may solve the simultaneous equations of Equation (1) and Equation (2) using the liquid density p corresponding to the temperature obtained by the temperature sensor 71. This makes it possible to calculate a more accurate flow rate. Note that the liquid density p corresponding to the temperature can be similarly used in Equation (3) and Equation (4) described later.

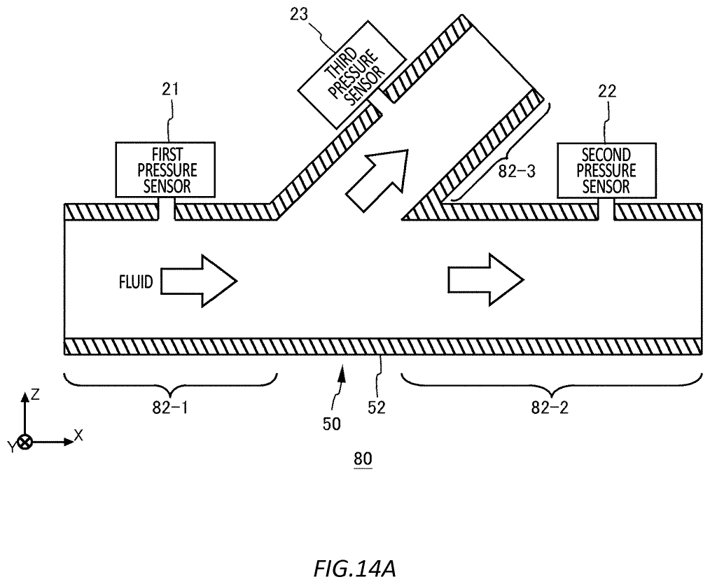

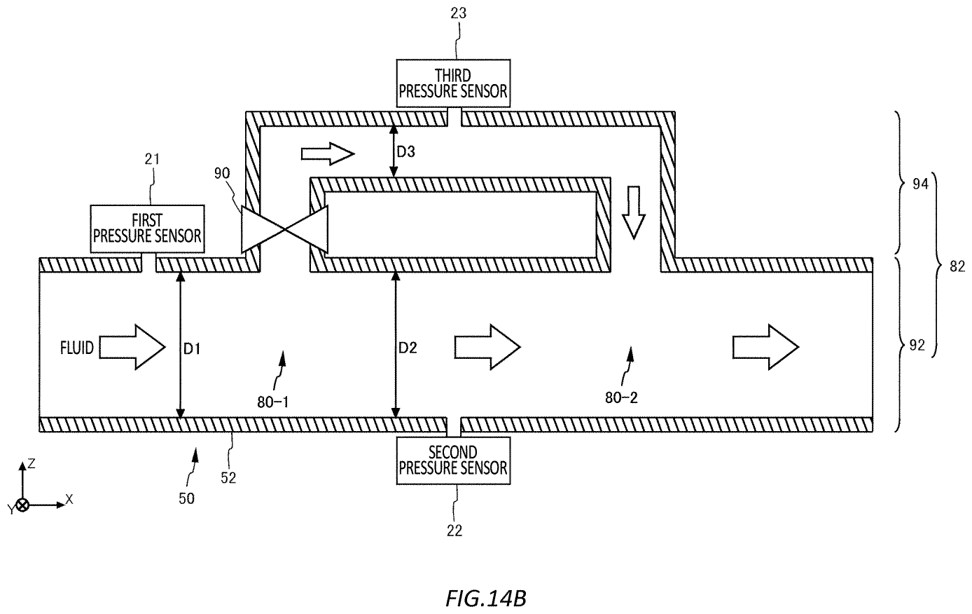

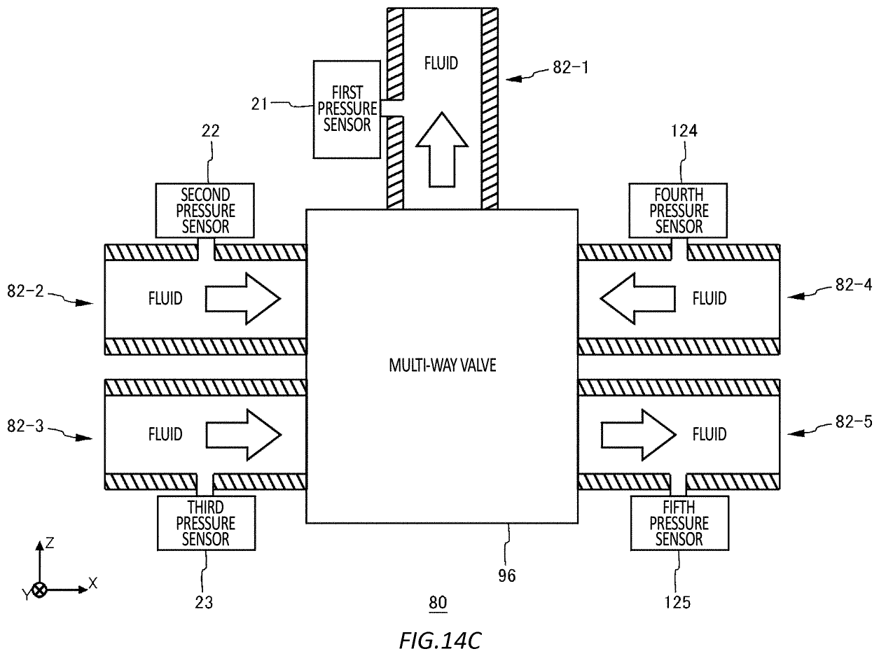

FIG. 14A is a diagram illustrating the arrangement of the pressure sensor at the connection point 80 of the flow passage 50. The flow passage 50 of the present example has the connection point 80 to which three or more branch passages 82 are connected. At the connection point 80 of the present example, a branch passage 82-1, a branch passage 82-2, and a branch passage 82-3 are connected. In the present specification, the branch passage 82 shall refer to all flow passages including a main flow at the connection point 80. That is, at the connection point 80 to which three or more flow passages 50 are connected, each flow passage 50 is referred to as the branch passage 82. When four or more branch passages 82 are provided at the connection point 80, all of the branch passages 82 may branch from the same branching positions, or may branch from the different branching positions. The connection point 80 may be a region including a plurality of branching positions. The connection point 80 may refer to a branching housing to which a plurality of branch passages 82 is connected. The respective branch passages 82 may be connected to each other inside the branching housing. A set of consecutive branching positions, in which an interval between the branching positions is within five times a diameter of a branch passage 82, may be regarded as one connection point 80. A range of the connection point 80 may be, for example, a range within five times a diameter of the flow passage 50 from a point at which extending directions of each branch passage 82 intersect. The diameter of the flow passage 50 may be an inner diameter of a pipe forming the flow passage 50.

At the connection point 80, one pressure sensor of a plurality of pressure sensors may be attached to each of at least three branch passages 82. The plurality of pressure sensors include the first pressure sensor 21 and second pressure sensor 22 described above. In the present example, the first pressure sensor 21 is attached to the branch passage 82-1, the second pressure sensor 22 is attached to the branch passage 82-2, and the third pressure sensor 23 is attached to the branch passage 82-3. The third pressure sensor 23 may have a configuration similar to those of the first pressure sensor 21 and the second pressure sensor 22. The third pressure sensor 23 is provided at a third position and outputs a third electric potential corresponding to the pressure of the fluid. The pressure sensor may be attached to all of the branch passages 82 at the connection point 80.

The electric potential difference detection unit 24 may detect the electric potential difference between the plurality of pressure sensors. The electric potential difference detection unit 24 of the present example detects the electric potential difference between the first electric potential and the second electric potential, the electric potential difference between the first electric potential and the third electric potential, and the electric potential difference between the second electric potential and the third electric potential.

By measuring respective pressure differences between the pressure P₁ at the first position, the pressure P₂ at the second position, and the pressure P₃ at the third position of the connection point 80, and by solving simultaneous equations of the following Equation (3) and Equation (5) from Bernoulli's principle, the flow rate Q can be calculated.

$$\begin{matrix}Equation 3 & \\ \frac{1}{2} {pv}_{1}^{2} + {P}_{1} + {pgh}_{1} = \frac{1}{2} {pv}_{2}^{2} + {P}_{2} + {pgh}_{2} & ( 3 )\end{matrix}$$

$$\begin{matrix}Equation 4 & \\ \frac{1}{2} {pv}_{1}^{2} + {P}_{1} + {pgh}_{1} = \frac{1}{2} {pv}_{3}^{2} + {P}_{3} + {pgh}_{3} & ( 4 )\end{matrix}$$

$$\begin{matrix}Equation 5 & \\ Q = {v}_{1} \cdot {S}_{1} = {v}_{2} \cdot {S}_{2} + {v}_{3} \cdot {S}_{3} & ( 5 )\end{matrix}$$

Characters and the like in the equations are the same as those in the case of Equation (1) and Equation (2).

Also in the present example, since the electric potential difference is detected and converted into a pressure difference, the influence of pulsation components can be removed. Further, according to the present example, since there is no need to narrow the flow passage 50 for measurement, clogging of the flow passage 50 and pressure loss can be suppressed. Further, the flow rates of all the branch passages 82 can be calculated. Furthermore, since the connection point 80 in the existing equipment can be used as it is, attachment is easy.

At the connection point 80 illustrated in FIG. 14A, fluid flowing through the branch passage 82-1 branches into the branch passage 82-2 and the branch passage 82-3; however, in the connection point 80, fluid flowing through two branch passages 82 may merge into one branch passage 82. In addition, the connection point 80 is not limited to one in which all branch passages 82 are connected at a single point. For example, a case in which another branch passage 82 branches at the branch passage 82-2 downstream of the branching point of the branch passage 82-3 in FIG. 14A shall also be included in the connection point 80.

FIG. 14B is a diagram illustrating another example of the connection point 80. The branch passage 82 of the present example has the main flow 92 and a bypass passage 94 of the flow passage 50. The main flow 92 is the main flow passage of the flow passage 50 through which fluid flows. The main flow 92 may be the flow passage 50 that connects respective components of the cooling system 100. The bypass passage 94 branches from the main flow 92 at the connection point 80-1 and merges into the main flow 92 at the connection point 80-2. At each connection point 80, the main flow 92 and the bypass passage 94 serve as the above-described branch passages 82.

In FIG. 14B, the pressure of the main flow 92 before and after the connection point 80-1 and the pressure of the bypass passage 94 are measured. Also in the present example, by measuring the pressure of each flow passage 50, the flow rate can be calculated in the same manner as in the case of FIG. 14A. The same applies to the connection point 80-2. Further, since providing the bypass passage 94 eliminates the need to narrow the main flow 92, it is possible to prevent clogging of the main flow 92 due to the addition of the measurement apparatus 20.

Let D1 be a diameter of the main flow 92 on an upstream side (the negative side of the X-axis in the figure) of the connection point 80, let D2 be a diameter of the main flow 92 on a downstream side (the positive side of the X-axis in the figure) of the connection point 80, and let D3 be a diameter of the bypass passage 94. The diameter D3 may be smaller than the diameter D1. By making the diameter of the bypass passage 94 smaller than the diameter of the main flow 92, the flow velocity of the bypass passage 94 increases, and the pressure (static pressure) tends to decrease. As a result, a pressure difference is generated even at a low flow rate, which facilitates measurement.

The diameter D2 may be the same as the diameter D1, and may be smaller than the diameter D1. The diameter D3 may be smaller than the diameter D2. A valve 90 may be provided at the connection point 80-1 between the main flow 92 and the bypass passage 94. The valve 90 may open and close in accordance with the flow rate of the fluid, and may adjust the flow rate of the bypass passage 94. For example, when the flow rate of the main flow 92 is high, the valve 90 is closed because a sufficient differential pressure is generated by a difference between the diameter D1 and the diameter D2. When the flow rate of the main flow 92 is low, the above differential pressure may not be sufficient; therefore, the valve 90 is opened to use the bypass passage 94 that is more likely to generate a differential pressure. This makes it possible to expand the range of flow rates that can be measured by the measurement apparatus 20. The ratio of the diameter D3 to the diameter D1 (contraction ratio) may be adjusted in accordance with the range of flow rates to be measured.

FIG. 14C is a diagram illustrating another example of the connection point 80. The connection point 80 of the present example is provided with a multi-way valve 96 which controls the flow rate of the fluid flowing through the branch passage 82. The multi-way valve 96 may be the electrically controlled valve or the solenoid valve. At the connection point 80 of the present example, the branch passages 82-1 to 82-5 are connected via the multi-way valve 96. The multi-way valve 96 may include a variable valve which controls a flow rate of each branch passage 82 or a direction in which the fluid flows.

Each branch passage 82 is provided with a pressure sensor. The fourth pressure sensor 124 provided in the branch passage 82-4 and the fifth pressure sensor 125 provided in the branch passage 82-5 may also have a configuration similar to that of the first pressure sensor 21 and the like. Even with such a configuration, since there is no need to narrow the flow passage 50 for flow rate measurement, clogging of the flow passage 50 and pressure loss can be suppressed. Further, the flow rates of all the branch passages 82 can be calculated. Furthermore, since the multi-way valve 96 in the existing equipment can be used as it is, installation is easy.

With reference to FIG. 1, the first pressure sensor 21 and the second pressure sensor 22 may be attached in the flow passage 50 between the suction port 11 of the liquid pump 10 and the object to be cooled 16. In other words, the pressure sensors may be attached to a return system of the cooling system 100. Since the pressure of the fluid becomes lower on the downstream side of the cooling system 100, the measurement range of the pressure sensors can be narrowed. Therefore, measurement accuracy is improved. The same may apply to the case where other pressure sensors, such as the third pressure sensor 23, are used.

However, a distance D4 (see FIG. 1) from the suction port 11 of the liquid pump 10 to the first pressure sensor 21 and the second pressure sensor 22 may be ten times or more the diameter of the flow passage 50. In the vicinity of the suction port 11 of the liquid pump 10, the flow is disturbed, and therefore the pressure of the fluid is not stable. By separating the pressure sensors from the suction port 11 to some extent, a stable pressure can be measured. The distance D4 may be 20 times or more, or may be 30 times or more the diameter of the flow passage 50. The same may apply to the case where other pressure sensors, such as the third pressure sensor 23, are used.

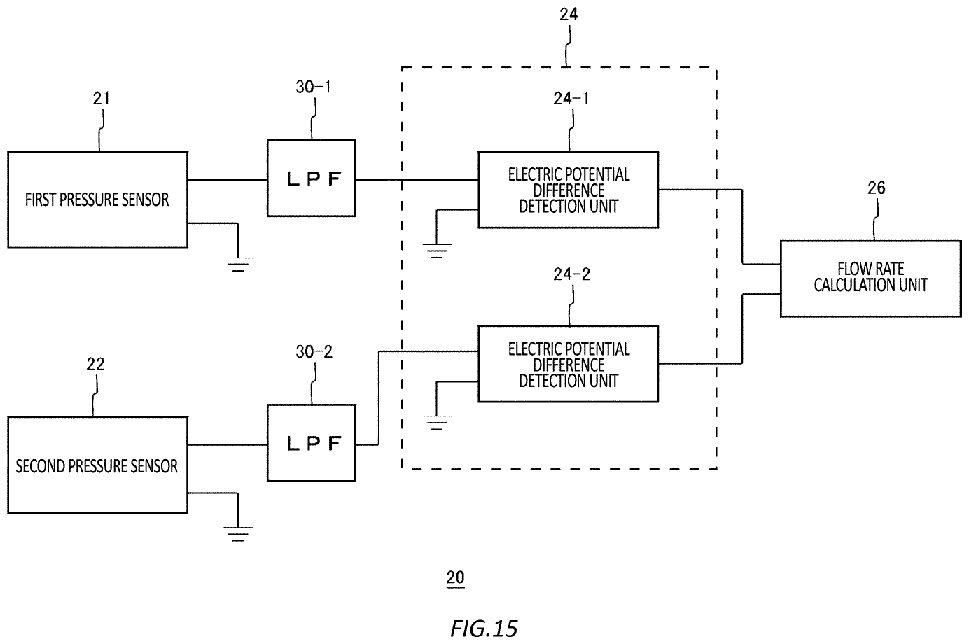

FIG. 15 is a diagram illustrating the circuit configuration of the measurement apparatus 20 according to the second embodiment of the present invention. For configurations similar to those described with reference to FIG. 3 and FIG. 5, description will be omitted as appropriate. The measurement apparatus 20 of the present example includes the electric potential difference detection unit 24, a first low-pass filter 30-1, and a second low-pass filter 30-2.

The electric potential difference detection unit 24 calculates the pressure of the fluid at the first position from the first electric potential, and calculates the pressure of the fluid at the second position from the second electric potential. The electric potential difference detection unit 24 of the present example includes the first electric potential difference detection unit 24-1 and the second electric potential difference detection unit 24-2. The first electric potential difference detection unit 24-1 calculates the pressure of the fluid at the first position from the first electric potential. The second electric potential difference detection unit 24-2 calculates the pressure of the fluid at the second position from the second electric potential. That is, the connection between each pressure sensor and the electric potential difference detection unit 24 is similar to the example illustrated in FIG. 5. Therefore, there is a case where a timing at which the first electric potential difference detection unit 24-1 calculates the pressure and a timing at which the second electric potential difference detection unit 24-2 calculates the pressure are different from each other.

The first low-pass filter 30-1 is provided between the first pressure sensor 21 and the electric potential difference detection unit 24. The first low-pass filter 30-1 filters the first electric potential. The second low-pass filter 30-2 is provided between the second pressure sensor 22 and the electric potential difference detection unit 24. The second low-pass filter 30-2 filters the second electric potential.

A cutoff frequency of the first low-pass filter 30-1 and the second low-pass filter 30-2 may be smaller than a reciprocal of the rotation period of the liquid pump 10. When pulsation of the fluid is generated by rotation of the liquid pump 10, the pulsation component can be removed by thereby removing the rotation frequency component of the liquid pump 10. Therefore, even if the timing at which the first electric potential difference detection unit 24-1 calculates the pressure and the timing at which the second electric potential difference detection unit 24-2 calculates the pressure are different from each other, an error due to a pulsation component can be suppressed. The cutoff frequency may be ½ or less, may be ⅕ or less, or may be 1/10 or less of the reciprocal of the rotation period of the liquid pump 10.

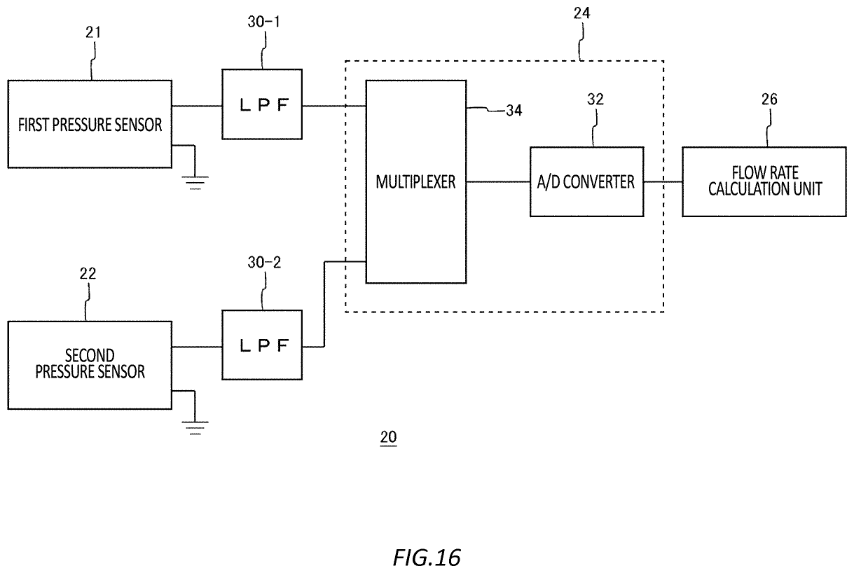

FIG. 16 is a diagram illustrating a modified example of the measurement apparatus 20 according to the second embodiment of the present invention. The electric potential difference detection unit 24 of the present example includes the A/D converter 32 and the multiplexer 34. In other words, the first low-pass filter 30-1 and the second low-pass filter 30-2 are provided in the measurement apparatus 200 illustrated in FIG. 6. Other points are the same as those in FIG. 15. As a result, even when the pressure is calculated sequentially using the multiplexer 34 as in the electric potential difference detection unit 24 of the present example, an error due to the pulsation component can be suppressed.

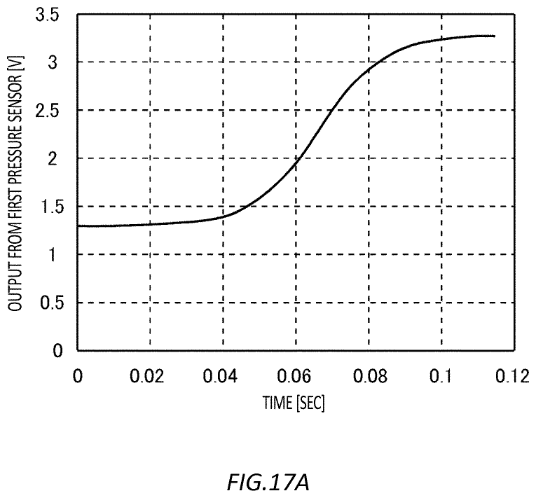

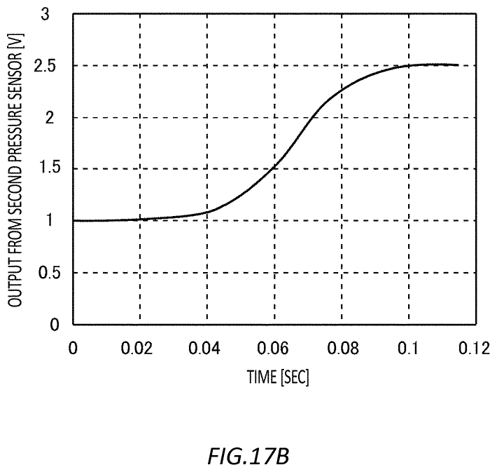

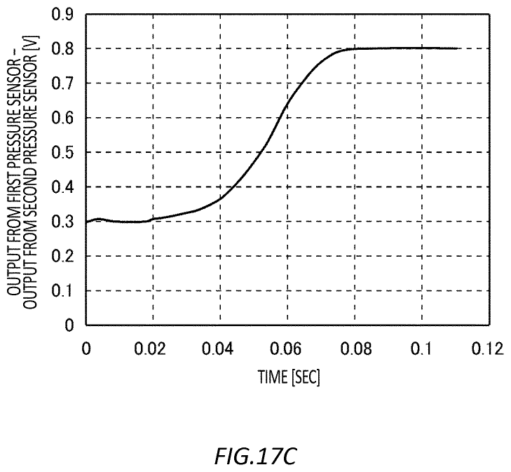

FIG. 17A is a diagram illustrating the output after the first low-pass filter 30-1 in FIG. 16. FIG. 17B is a diagram illustrating an output after the second low-pass filter 30-2 in FIG. 16. In FIG. 17A and FIG. 17B, the horizontal axis represents time, and the vertical axis represents the electric potential output from each sensor. Since the flow rate is increased in FIG. 17A and FIG. 17B, the output increases over time. No pulsation component was observed in the output from any of the sensors.

FIG. 17C is a diagram illustrating the output difference (electric potential difference) between FIG. 17A and FIG. 17B. In the circuit illustrated in FIG. 16, a time difference of 3 ms occurs in channel switching by the multiplexer 34. However, since the pulsation component is removed from each output by the low-pass filter, the pulsation component can also be removed in the output difference illustrated in FIG. 17C.

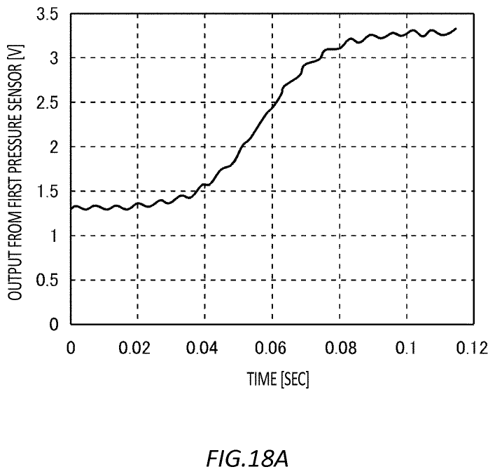

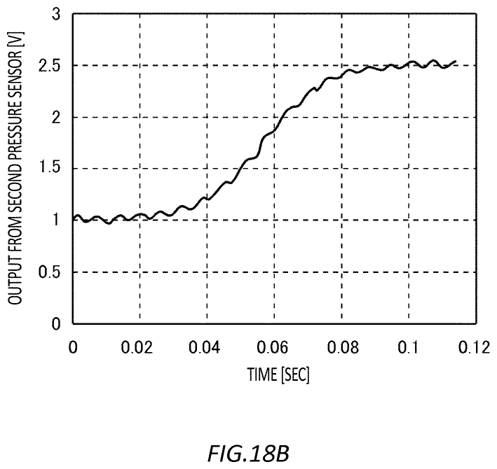

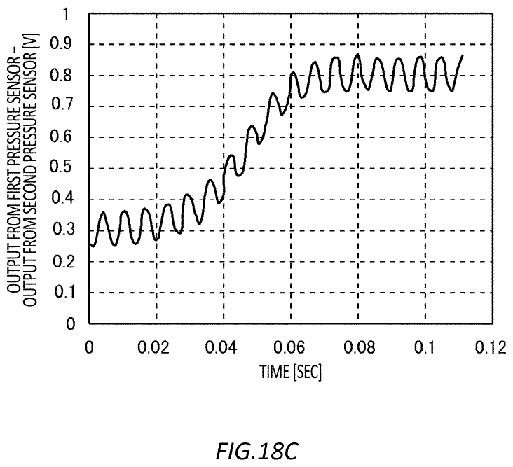

FIG. 18A is a diagram illustrating the output from the first pressure sensor 21 according to a comparative example. FIG. 18B is a diagram illustrating an output from the second pressure sensor 22 according to a comparative example. In FIG. 18A and FIG. 18B, the horizontal axis represents time, and the vertical axis represents the electric potential output from each sensor. The comparative example is a configuration in which no low-pass filter is provided in the measurement apparatus 20 illustrated in FIG. 16 (the same configuration as the measurement apparatus 200 illustrated in FIG. 6). Since the flow rate is increased in FIG. 18A and FIG. 18B, the output increases over time. In FIG. 18A and FIG. 18B, the output from each sensor includes the pulsation component of 160 Hz.

FIG. 18C is a diagram illustrating the output difference (electric potential difference) between FIG. 18A and FIG. 18B. Also in the measurement apparatus of the comparative example, a time difference of 3 ms occurs in channel switching by the multiplexer 34. Therefore, magnitudes of the pulsation component included in the output from respective sensors are different from each other (see FIG. 7), and an error due to the pulsation components increases as a result of combining them.

While the present invention has been described by way of the embodiments, the technical scope of the present invention is not limited to the range described in the above-described embodiments. It is apparent to persons skilled in the art that various alterations or improvements can be added to the above-described embodiments. It is also apparent from the described scope of the claims that the embodiments added with such alterations or improvements can be included the technical scope of the present invention.

What is claimed is:

1. A measurement apparatus for measuring a pressure difference of a fluid between a first position and a second position in a flow passage of the fluid, the measurement apparatus comprising:
a first pressure sensor which is provided at the first position and which outputs a first electric potential corresponding to a pressure of the fluid;
a second pressure sensor which is provided at the second position and which outputs a second electric potential corresponding to a pressure of the fluid; and
an electric potential difference detection unit which detects an electric potential difference between the first electric potential and the second electric potential, and converts the electric potential difference into the pressure difference.

2. The measurement apparatus according to claim 1, wherein the electric potential difference detection unit detects the electric potential difference, which is a difference between a first electric potential analog signal indicating the first electric potential and a second electric potential analog signal indicating the second electric potential, and converts the electric potential difference into the pressure difference as a digital signal.

3. The measurement apparatus according to claim 1, further comprising a differential amplifier which amplifies a difference between a first electric potential analog signal indicating the first electric potential and a second electric potential analog signal indicating the second electric potential, and outputs an electric potential difference analog signal indicating the electric potential difference.

4. The measurement apparatus according to claim 1, wherein the electric potential difference detection unit obtains in advance an offset value that is the electric potential difference in a state in which the fluid is not flowing through the flow passage, and corrects the pressure difference using the offset value.

5. The measurement apparatus according to claim 4, further comprising a temperature sensor which detects a temperature of the fluid,
wherein the electric potential difference detection unit obtains the offset value for each temperature of the fluid.

6. The measurement apparatus according to claim 1, wherein
the flow passage has a connection point to which three or more branch passages are connected, and
at the connection point, one pressure sensor of a plurality of pressure sensors including the first pressure sensor and the second pressure sensor is attached to each of at least three of the branch passages, and an electric potential difference between the plurality of pressure sensors is detected.

7. The measurement apparatus according to claim 6, wherein the branch passage includes a main flow of the flow passage and a bypass passage having a smaller diameter than the main flow.

8. The measurement apparatus according to claim 6, wherein the connection point is provided with an electrically controlled valve or a solenoid valve which controls a flow rate of the fluid flowing through the branch passage.

9. The measurement apparatus according to claim 1, further comprising a temperature sensor which detects a temperature of the fluid.

10. The measurement apparatus according to claim 1, further comprising a flow rate calculation unit which calculates a flow rate of the fluid from the pressure difference.

11. The measurement apparatus according to claim 1, wherein
the measurement apparatus is used in a cooling system which cools an object to be cooled by causing the fluid to flow through the flow passage by a liquid pump, and
the first pressure sensor and the second pressure sensor are attached between a suction port of the liquid pump and the object to be cooled in the flow passage.

12. The measurement apparatus according to claim 11, wherein a distance from the suction port of the liquid pump to the first pressure sensor and the second pressure sensor is ten times or more a diameter of the flow passage.

13. The measurement apparatus according to claim 6, wherein
the plurality of pressure sensors include a third pressure sensor which is provided at a third position and outputs a third electric potential corresponding to a pressure of the fluid, and
the electric potential difference detection unit detects an electric potential difference between the first electric potential and the second electric potential, an electric potential difference between the first electric potential and the third electric potential, and an electric potential difference between the second electric potential and the third electric potential.

14. The measurement apparatus according to claim 7, wherein the bypass passage merges into a main flow of the flow passage at another one of the connection point.

15. The measurement apparatus according to claim 11, wherein
the flow passage is provided in a looped configuration from a discharge port of the liquid pump via the object to be cooled to the suction port of the liquid pump, and
the first pressure sensor and the second pressure sensor are attached between the object to be cooled and the suction port of the liquid pump in a flow direction of the fluid in the flow passage.

16. A measurement apparatus for measuring a pressure difference of a fluid between a first position and a second position in a flow passage of the fluid, the measurement apparatus comprising:
a first pressure sensor provided at the first position, which outputs a first electric potential corresponding to a pressure of the fluid;
a second pressure sensor provided at the second position, which outputs a second electric potential corresponding to a pressure of the fluid;
an electric potential difference detection unit which calculates a pressure of the fluid at the first position from the first electric potential, and calculates a pressure of the fluid at the second position from the second electric potential;
a first low-pass filter which is provided between the first pressure sensor and the electric potential difference detection unit and which filters the first electric potential; and
a second low-pass filter which is provided between the second pressure sensor and the electric potential difference detection unit and which filters the second electric potential.

17. The measurement apparatus according to claim 16, wherein
the measurement apparatus is used in a cooling system which cools an object to be cooled by causing the fluid to flow through the flow passage by a liquid pump, and
cutoff frequencies of the first low-pass filter and the second low-pass filter are lower than a reciprocal of a rotation period of the liquid pump.

18. The measurement apparatus according to claim 17, wherein the cutoff frequencies of the first low-pass filter and the second low-pass filter are ⅕ or less of a reciprocal of a rotation period of the liquid pump.

19. The measurement apparatus according to claim 2, wherein
the measurement apparatus is used in a cooling system which cools an object to be cooled by causing the fluid to flow through the flow passage by a liquid pump, and
the first pressure sensor and the second pressure sensor are attached between a suction port of the liquid pump and the object to be cooled in the flow passage.

20. The measurement apparatus according to claim 3, wherein
the measurement apparatus is used in a cooling system which cools an object to be cooled by causing the fluid to flow through the flow passage by a liquid pump, and
the first pressure sensor and the second pressure sensor are attached between a suction port of the liquid pump and the object to be cooled in the flow passage.
